(19) United States
(12) Patent Application Publication
(10) Pub. No.: US 2020/0361239 A1
(43) Pub. Date: Nov. 19, 2020

(54) FRONT WHEEL TRANSMISSION TURNING DEVICE FOR A VEHICLE

(71) Applicant: FENG-TIEN CHEN, Taichung City (TW)

(72) Inventor: FENG-TIEN CHEN, Taichung City (TW)

(21) Appl. No.: 16/515,125

(22) Filed: Jul. 18, 2019

(30) Foreign Application Priority Data
May 17, 2019 (TW) 108117153

(51) Int. Cl. B60B 35/12; F16D 3/221

(52) U.S. Cl. CPC B60B 35/128; B60K 17/354; F16D 3/221

(57) ABSTRACT

A front wheel transmission turning device for a vehicle is adapted to be coupled to a transmission shaft and installed at a vehicle wheel, and includes a plurality of balls, an outer annular seat having a plurality of angularly spaced-apart outer grooves, and an inner annular seat having a plurality of angularly spaced-apart inner grooves. A quantity of the balls is not smaller than three, and a quantity of the outer grooves is a multiple of and larger than the quantity of the balls. The balls are equiangularly arranged and each of the balls is removably received between a corresponding one of the outer grooves and a corresponding one of the inner grooves.

### CROSS-REFERENCE TO RELATED APPLICATION

This application claims priority of Taiwanese Invention Patent Application No. 108117153, filed on May 17, 2019.

### FIELD

The disclosure relates to a transmission turning device, more particularly to a front wheel transmission turning device for a vehicle.

### BACKGROUND

Referring to FIGS. 1 and 2, a conventional front-wheel drive vehicle uses a universal joint 1 installed between a front wheel (not shown) and a transmission shaft 10 in order to achieve transmission during front-wheel driven turning of the vehicle. The universal joint 1 includes an inner socket seat 11 sleeved on the transmission shaft 10, an outer socket seat 12 housing the inner socket seat 11, a holder 13 disposed between the inner and outer socket seats 11, 12, a plurality of steel balls 14 rotatably disposed in the holder 13, and an axial shaft 15 disposed on said outer socket seat 13 and to be connected to the front wheel. Each of the inner and outer socket seats 11, 12 has a plurality of sockets 111, 121 corresponding in quantity to the balls 14. The holder 13 positions the balls 14 respectively in the sockets 111 of the inner socket seat 11 and respectively in the sockets 121 of the outer socket seat 12. When the inner socket seat 11 is rotated at a angle relative to the outer socket seat 12, the balls 14 may act as a contact point therebetween to thereby allow the transmission of angular power between the transmission shaft 10 and the axial shaft 15.

However, since the hardness of the outer socket seat 12 is lower than that of the balls 14, after long-term use, the sockets 121 of the outer socket seat 12 are worn by the balls 14 and the entire universal joint 1 must be replaced, increasing the cost of maintenance.

### SUMMARY

Therefore, the object of the disclosure is to provide a front wheel transmission turning device for a vehicle that has a longer service life.

According to the disclosure, a front wheel transmission turning device for a vehicle is adapted to be coupled to a transmission shaft and installed at a vehicle wheel. The front wheel transmission turning device for a vehicle includes a plurality of balls, an outer annular seat, an inner annular seat, a holding member, and a connecting shaft.

A quantity of the balls being not smaller than three;

The outer annular seat includes a base wall and an annular wall that extends from the base wall. The annular wall has an inner annular surface, an outer annular surface opposite to and surrounding the inner annular surface, and a top annular surface interconnecting the inner and outer annular surfaces and opposite to the base wall. The inner annular surface surrounds an axis and defines a receiving space. The inner annular surface has a plurality of angularly spaced-apart outer grooves extending from the top annular surface toward the base wall. A quantity of the outer grooves is a multiple of and larger than the quantity of the balls.

The inner annular seat is removably disposed in the receiving space of the outer annular seat and rotatable relative to the outer annular seat. The inner annular seat includes an inner wall surface and an outer wall surface that is opposite to and that surrounds the inner wall surface. The inner wall surface defines a connection hole adapted for engagingly fitting the transmission shaft. The outer wall surface has a plurality of angularly spaced-apart inner grooves. A quantity of the inner grooves is a multiple of and not smaller than the quantity of the balls. Each of the inner grooves faces a corresponding one of the outer groove.

The holding member is removably disposed between the outer and inner annular seats, and co-rotatable with the inner annular seat relative to the outer annular seat. The holding member has an inner surrounding surface, an outer surrounding surface opposite to and surrounding the inner surrounding surface, and a plurality of angularly spaced-apart through holes extending from the inner surrounding surface to the outer surrounding surface. A quantity of the through holes is a multiple of and not smaller than the quantity of the balls. Each of the through holes faces a corresponding one of the outer grooves.

The connecting shaft is mounted to the base wall of the outer annular seat, extends along the axis away from the annular wall, and is adapted for connecting to the vehicle wheel.

The balls are equiangularly arranged. Each of the balls is removably disposed in a corresponding one of the through holes of the holding member, and removably received between a corresponding one of the outer grooves and a corresponding one of the inner grooves.

### BRIEF DESCRIPTION OF THE DRAWINGS

Other features and advantages of the disclosure will become apparent in the following detailed description of the embodiments with reference to the accompanying drawings, of which:

FIG. 1 is a perspective view of a conventional universal joint;

FIG. 2 is an exploded perspective view of the conventional universal joint;

FIG. 3 is an exploded perspective view of a first embodiment of a front wheel transmission turning device for a vehicle according to the disclosure;

FIG. 4 is a sectional view of the first embodiment, illustrating three balls installed in a set of three outer grooves of an outer annular seat;

FIG. 5 is a sectional view of the first embodiment, illustrating the balls installed in another set of three outer grooves of the outer annular seat;

FIG. 6 is similar to FIG. 4, illustrating a variation of the first embodiment;

FIG. 7 is a sectional view of a second embodiment of the front wheel transmission turning device for a vehicle according to the disclosure, illustrating four of the balls installed in a set of four outer grooves of the outer annular seat;

FIG. 8 is similar to FIG. 7, illustrating the balls installed in another set of four outer grooves of the outer annular seat;

FIG. 9 is similar to FIG. 7, illustrating a variation of the second embodiment;

FIG. 10 is a sectional view of a third embodiment of the front wheel transmission turning device for a vehicle according to the disclosure, illustrating six of the balls installed in a set of six outer grooves of the outer annular set;

FIG. 11 is similar to FIG. 10, illustrating the balls installed in another set of six outer grooves of the outer annular seat;

FIG. 12 is similar to FIG. 10, illustrating a first variation of the third embodiment; and

FIG. 13 is similar to FIG. 10, illustrating a second variation of the third embodiment.

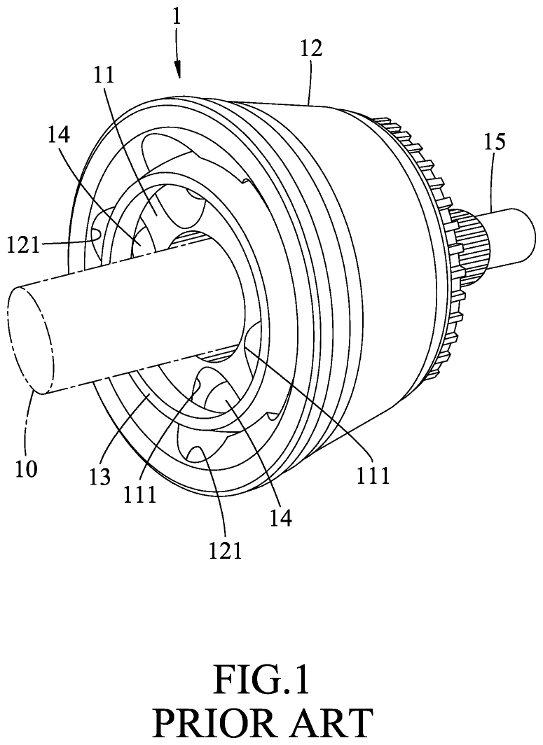

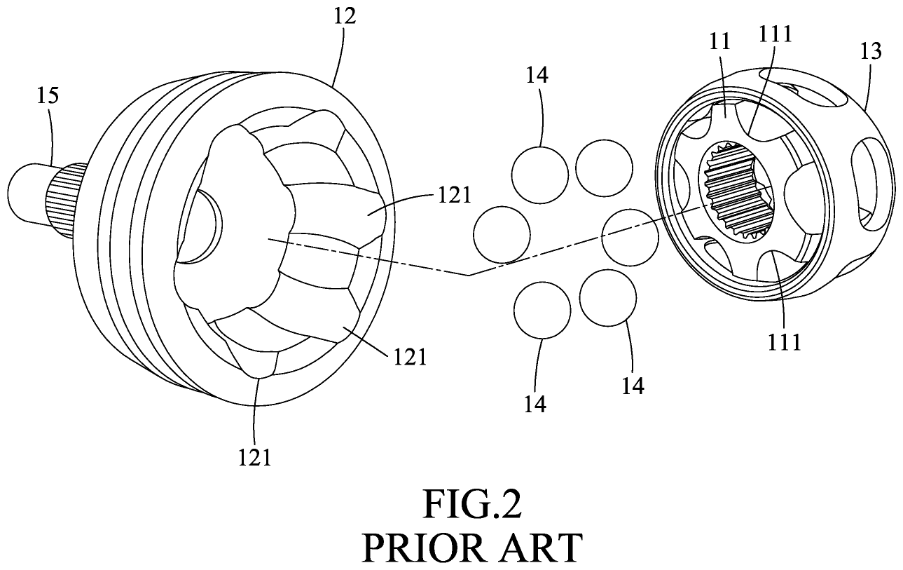

### DETAILED DESCRIPTION

Before the present invention is described in greater detail, it should be noted that where considered appropriate, reference numerals or terminal portions of reference numerals have been repeated among the figures to indicate corresponding or analogous elements, which may optionally have similar characteristics.

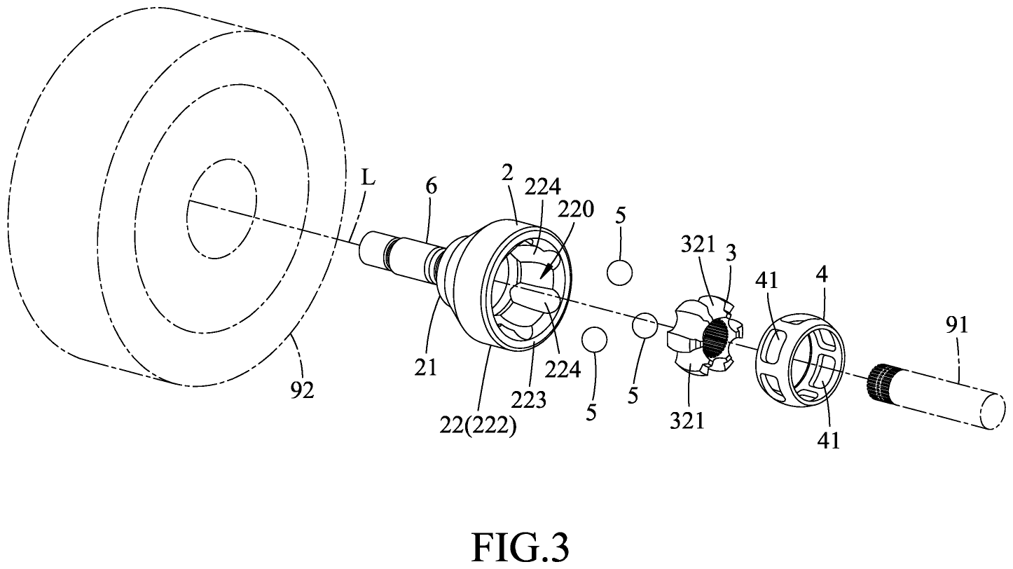

Referring to FIGS. 3 to 5, a first embodiment of a front wheel transmission turning device for a vehicle is adapted to be coupled to a transmission shaft 91 and installed at a vehicle wheel 92. In this embodiment, the wheel is a front wheel of the vehicle. The front wheel transmission turning device for a vehicle includes an outer annular seat 2, an inner annular seat 3, a holding member 4, a plurality of balls 5, and a connecting shaft 6.

The outer annular seat 2 includes a base wall 21 and an annular wall 22 that extends from the base wall 21. The annular wall 22 has an inner annular surface 221, an outer annular surface 222 opposite to and surrounding the inner annular surface 221, and a top annular surface 223 interconnecting the inner and outer annular surfaces 221, 222 and opposite to the base wall 21. The inner annular surface 221 surrounds an axis (L), defines a receiving space 220, and has a plurality of angularly spaced-apart outer grooves 224 that extend from the top annular surface 223 toward the base wall 21.

The inner annular seat 3 is removably disposed in the receiving space 220 of the outer annular seat 2 and is rotatable relative to the outer annular seat 2. Specifically, the inner annular seat 3 is capable of tilting relative to the outer annular seat 2 so that a rotational axis of the inner annular seat 3 is at an angle to the axis (L) of the outer annular seat 2, thereby enabling the inner annular seat 3 to transmit rotation to the outer annular seat 2 even when the vehicle wheel 92 in a state of turning. The inner annular seat 3 includes an inner wall surface 31 and an outer wall surface 32 opposite to and surrounding the inner wall surface 31. The inner wall surface 31 defines a connection hole 30 adapted for engagingly fitting the transmission shaft 91. The outer wall surface 32 has a plurality of angularly spaced-apart inner grooves 321, each of the inner grooves 321 facing a corresponding one of the outer groove 224. The inner annular seat 3 is made of a material that has a greater hardness than that of the outer annular seat 2.

The holding member 4 is removably disposed between the outer and inner annular seats 2, 3, and co-rotatable with the inner annular seat 3 relative to the outer annular seat 2. The holding member 4 has an inner surrounding surface, an outer surrounding surface opposite to and surrounding the inner surrounding surface, and a plurality of angularly spaced-apart through holes 41 extending from the inner surrounding surface to the outer surrounding surface, each of the through holes 41 facing a corresponding one of the outer grooves 321.

The connecting shaft 6 is mounted to the base wall 21 of the outer annular seat 2, extends along the axis (L) away from the annular wall 22, and is adapted for connecting to the vehicle wheel 92.

The balls 5 are equiangularly arranged, and each of the balls 5 is removably disposed in a corresponding one of the through holes 41 of the holding member 4, and removably received between a corresponding one of the outer grooves 224 and a corresponding one of the inner grooves 321.

A quantity of the balls 5 is not smaller than three, a quantity of the outer grooves 224 is a multiple of and larger than the quantity of the balls 5, a quantity of the inner grooves 321 is a multiple of and not smaller than the quantity of the balls 5, and a quantity of the through holes 41 is a multiple of and not smaller than the quantity of the balls 5.

In certain embodiments, the quantity of the outer grooves 224 is twelve, the quantity of the inner grooves 321 is one of three, six and twelve, the quantity of the through holes 41 is one of three, six and twelve, and the quantity of the balls 5 is three.

In certain embodiments, the quantity of the outer grooves 224 is twelve, the quantity of the inner grooves 321 is four, the quantity of the through holes 41 is one of four and twelve, and the quantity of the balls 5 is four.

In certain embodiments, the quantity of the outer grooves 224 is twelve, the quantity of the inner grooves 321 is six, the quantity of the through holes 41 is one of six and twelve, and the quantity of the balls 5 is one of three and six.

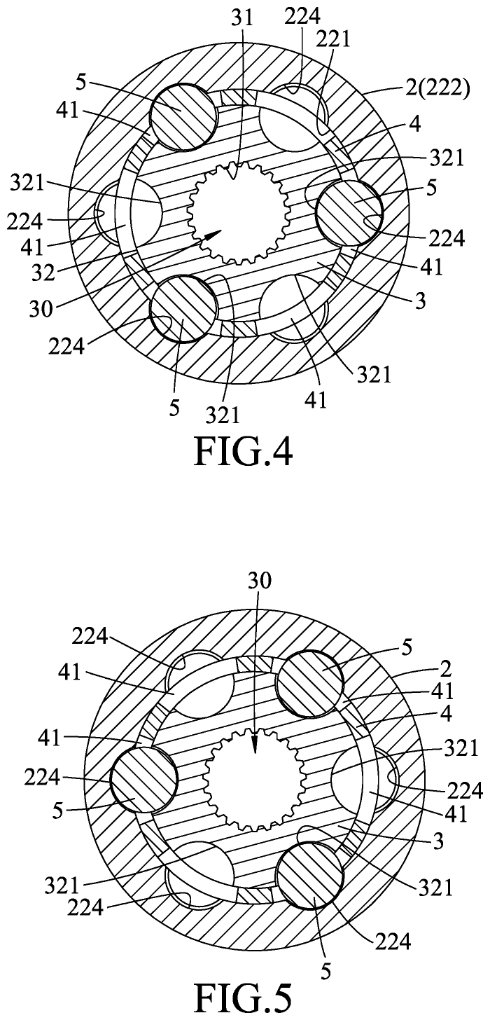

Referring to FIGS. 4 and 5, in this embodiment, the quantities of the balls 5 is three, and each of the quantities of the outer grooves 224, the inner grooves 321, and the through holes 41 is six. The outer grooves 224 may be divided into two sets of three that are arranged equiangularly to match the balls 5. In this embodiment, the outer grooves 224 are arranged triangularly. As shown in FIG. 4, the balls 5 are initially received respectively in three of the inner grooves 231 and respectively in three of the through holes 41, then the balls 5, the inner annular seat 3 and the holding member 4 are installed into the outer annular seat 2 for operation of the front wheel transmission turning device for a vehicle in the vehicle, the balls 5 being respectively received in the three outer grooves 224 of one of the sets. When the outer annular seat 2 has been worn at the outer grooves 224 by the balls 5 to the point where the front wheel transmission turning device for a vehicle can no longer perform properly, the balls 5, the inner annular seat 3, and the holding member 4 may be disassembled from the outer annular seat 2, and reinstalled such that the balls 5 are respectively received in the three outer grooves 224 of the other set. Hence, relative to the conventional transmission device, the front wheel transmission turning device for a vehicle of this embodiment may double its service life. In this embodiment, when changing the set of outer grooves 224 that receives the balls 5 from one set to another set, the balls 5 may optionally be moved into another three of the inner grooves 321 and another three of the through holes 41.

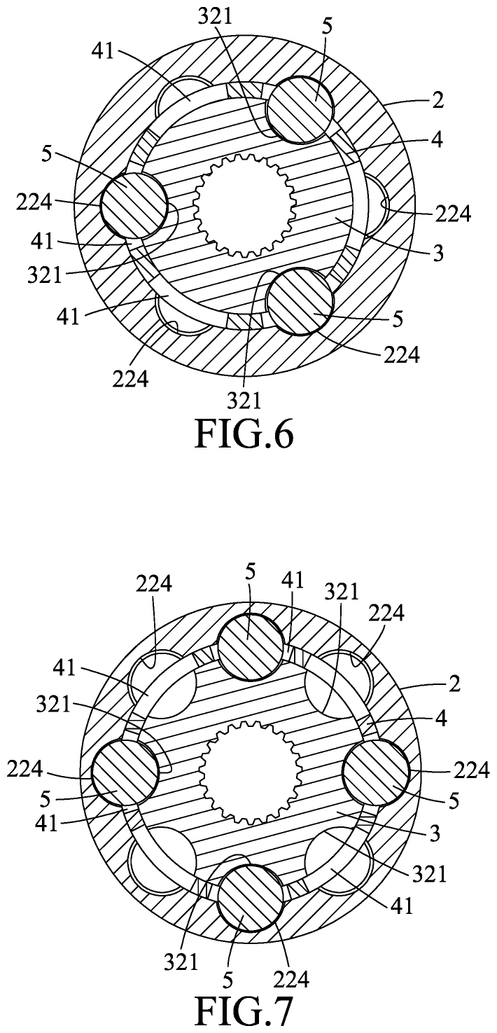

Referring to FIG. 6, in a variation of the first embodiment, the quantity of the inner grooves 321 is three. In this embodiment, the balls 5 stay in the same inner grooves 321 and through holes 41 when changed to a different set of the outer grooves 224. This variation can achieve the same benefit as the previous configuration because the material of the inner annular seat 3 is harder than that of the outer annular seat 2, and so the inner grooves 321 do not get worn down as fast as the outer grooves 224. The through holes 41 are also worn down slower, and thus, the quantity of the through holes 41 may also be three.

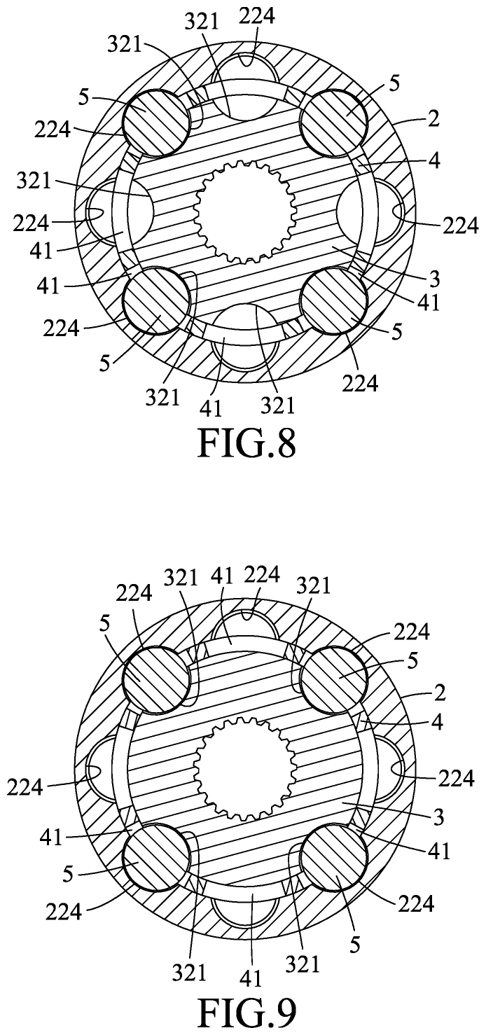

Referring to FIGS. 7 and 8, a second embodiment of the front wheel transmission turning device for a vehicle is similar to the first embodiment, except that the quantity of the balls 5 is four, and each of the quantities of the outer grooves 224, the inner grooves 321 and the through holes 41 is eight. The outer grooves 224 are divided into two sets of four. The outer grooves 224 in each of the sets are arranged in an equiangular arrangement, i.e., a square arrangement, to match the balls 5. Similarly, the balls 5 are respectively received in the four outer grooves 224 of one of the sets of the outer grooves 224. When the outer annular seat 2 has been worn at the outer grooves 224, the balls 5 are moved to the other set of the outer grooves 224. Similarly, when changing the set of outer grooves 224 that receives the balls 5 from one set to another set, the balls 5 may optionally be moved into another four of the inner grooves 321 and another four of the through holes 41.

Referring to FIG. 9, a variation of the second embodiment is similar in structure to second embodiment, but differs in having a reduced quantity of the inner groove 321 as the inner annular seat 3 is harder and is unlikely to be worn. In this variation, the quantity of the inner groove 321 is four (i.e. equal to the quantity of the balls 5). For similar reasons, the quantity of the through holes 41 may also be four.

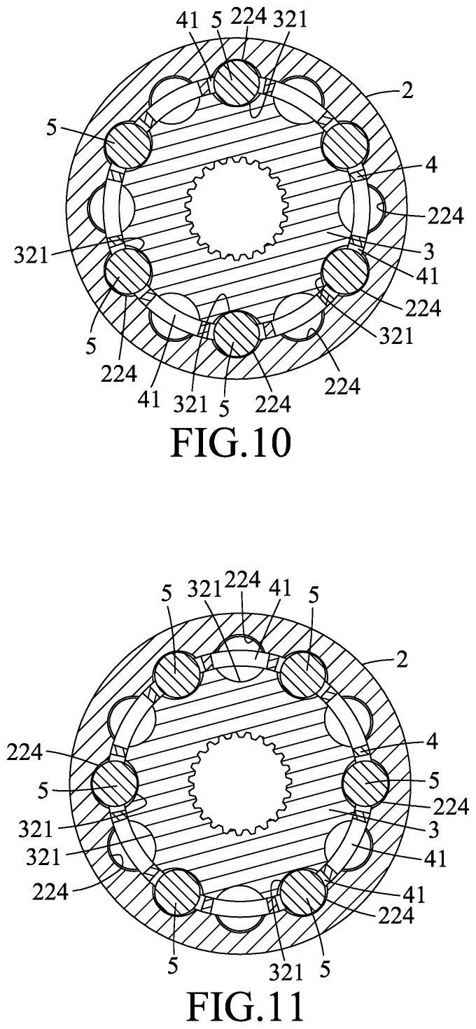

Referring to FIGS. 10 and 11, a third embodiment of the front wheel transmission turning device for a vehicle is similar to the first embodiment, except that the quantity of the balls 5 is six, and each of the quantities of the outer grooves 224, the inner grooves 321 and the throughholes 41 is twelve. The outer grooves 224 are divided into two sets of six. The outer grooves 224 in each of the sets are arranged in an equiangular arrangement, i.e., a hexagonal arrangement, to match the balls 5. Similarly, the balls 5 are respectively received in one of the sets of the outer grooves 224. When the outer annular seat 2 has been worn at the outer grooves 224, the balls 5 are moved to the other set of the outer grooves 224. Similarly, when changing the set of outer grooves 224 that receives the balls 5 from one set to another set, the balls 5 may optionally be moved into another six of the inner grooves 321 and another six of the through holes 41.

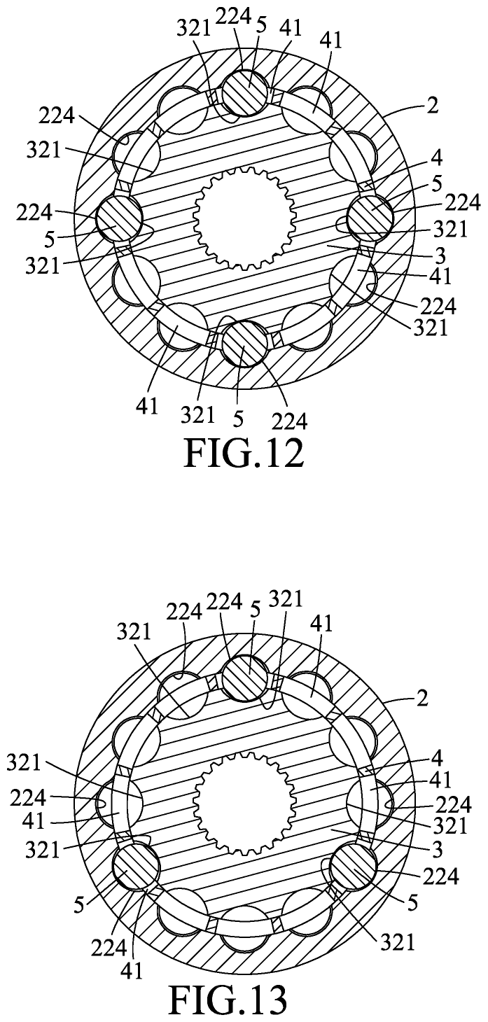

FIG. 12 shows a first variation of the third embodiment, in which the quantity of the balls 5 is four. Correspondingly, the outer grooves 224 are divided into three sets of four. The outer grooves 224 of each of the sets are arranged in an equiangular arrangement, i.e. a square arrangement, to match the balls 5. In this variation, the balls 5 may sequentially be received in the three sets of the outer grooves 224, and the service life is triple that of the conventional transmission device.

FIG. 13 shows a second variation of the third embodiment, the quantity of the balls 5 is three. Correspondingly, the outer grooves 224 are divided into four sets of three. The outer grooves 224 of each of the sets are arranged in an equiangular arrangement, i.e. a triangular arrangement, to match the balls 5. In this variation, the balls 5 may sequentially be received in the four sets of the outer grooves 224, and the service life is quadruple that of the conventional transmission device.

In the aforesaid embodiments and the variations thereof, the front wheel transmission turning device for a vehicle is a universal joint, e.g., a constant-velocity joint.

In sum, the front wheel transmission turning device for a vehicle of this disclosure has the outer grooves 224 with a quantity that is larger than and a multiple of the balls 5 so that the balls 5 may sequentially be received in multiple sets of the outer grooves 224 before the entire front wheel transmission turning device for a vehicle needs to be replaced, which lengthens the service life of the front wheel transmission turning device for a vehicle of this disclosure compared to the conventional transmission device.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A front wheel transmission turning device for a vehicle adapted to be coupled to a transmission shaft and installed at a vehicle wheel, said front wheel transmission turning device for a vehicle comprising:
a plurality of balls, a quantity of said balls being not smaller than three;
an outer annular seat including a base wall and an annular wall that extends from said base wall, said annular wall having an inner annular surface, an outer annular surface that is opposite to and that surrounds said inner annular surface, and a top annular surface that interconnects said inner and outer annular surfaces and that is opposite to said base wall, said inner annular surface surrounding an axis and defining a receiving space, said inner annular surface having a plurality of angularly spaced-apart outer grooves that extend from said top annular surface toward said base wall, a quantity of said outer grooves being a multiple of and larger than said quantity of said balls;
an inner annular seat removably disposed in said receiving space of said outer annular seat and being rotatable relative to said outer annular seat, said inner annular seat including an inner wall surface and an outer wall surface that is opposite to and that surrounds said inner wall surface, said inner wall surface defining a connection hole adapted for engagingly fitting the transmission shaft, said outer wall surface having a plurality of angularly spaced-apart inner grooves, a quantity of said inner grooves being a multiple of and not smaller than said quantity of said balls, each of said inner grooves facing a corresponding one of said outer groove;
a holding member removably disposed between said outer and inner annular seats, and being co-rotatable with said inner annular seat relative to said outer annular seat, said holding member having an inner surrounding surface, an outer surrounding surface that is opposite to and that surrounds the inner surrounding surface, and a plurality of angularly spaced-apart through holes that extend from said inner surrounding surface to said outer surrounding surface, a quantity of said through holes being a multiple of and not smaller than said quantity of said balls, each of said through holes facing a corresponding one of said outer grooves; and
a connecting shaft mounted to said base wall of said outer annular seat, extending along the axis away from said annular wall, and adapted for connecting to the vehicle wheel,
wherein said balls are equiangularly arranged, each of said balls being removably disposed in a corresponding one of said through holes of said holding member, and removably received between a corresponding one of said outer grooves and a corresponding one of said inner grooves.

2. The front wheel transmission turning device for a vehicle as claimed in claim 1, wherein said quantity of said outer grooves is six, said quantity of said inner grooves is one of three and six, said quantity of said through holes is one of three and six, and said quantity of said balls is three.

3. The front wheel transmission turning device for a vehicle as claimed in claim 2, wherein said quantity of said inner grooves is equal to said quantity of said balls.

4. The front wheel transmission turning device for a vehicle as claimed in claim 1, wherein said quantity of said outer grooves is eight, said quantity of said inner grooves is one of four and eight, said quantity of said through holes is one of four and eight, and said quantity of said balls is four.

5. The front wheel transmission turning device for a vehicle as claimed in claim 4, wherein said quantity of said inner grooves is equal to said quantity of said balls.

6. The front wheel transmission turning device for a vehicle as claimed in claim 1, wherein said quantity of said outer grooves is twelve, said quantity of said inner grooves is three, said quantity of said through holes is one of three, six and twelve, and said quantity of said balls is three.

7. The front wheel transmission turning device for a vehicle as claimed in claim 1, wherein said quantity of said outer grooves is twelve, said quantity of said inner grooves is four, said quantity of said through holes is one of four and twelve, and said quantity of said balls is four.

8. The front wheel transmission turning device for a vehicle as claimed in claim 1, wherein said quantity of said outer grooves is twelve, said quantity of said inner grooves is six, said quantity of said through holes is one of six and twelve, and said quantity of said balls is one of three and six.

9. The front wheel transmission turning device for a vehicle as claimed in claim 1, wherein said quantity of said outer grooves is twelve, said quantity of said inner grooves is twelve, said quantity of said through holes is twelve, and said quantity of said balls is one of three, four and six.

10. The front wheel transmission turning device for a vehicle as claimed in claim 1, wherein said front wheel transmission turning device for a vehicle is a universal joint.
